(19) United States
(12) Patent Application Publication
(10) Pub. No.: US 2024/0170012 A1
(43) Pub. Date: May 23, 2024

(54) MAGNETIC TAPE, MAGNETIC TAPE CARTRIDGE, AND MAGNETIC RECORDING AND REPRODUCING APPARATUS

(71) Applicant: FUJIFILM Corporation, Tokyo (JP)

(72) Inventors: Takashi IMAI, Minamiashigara-shi (JP); Yuki FUKUOKA, Minamiashigara-shi (JP); Takashi MATSUI, Minamiashigara-shi (JP); Daisuke SAWAI, Minamiashigara-shi (JP)

(73) Assignee: FUJIFILM Corporation, Tokyo (JP)

(21) Appl. No.: 18/308,088

(22) Filed: Apr. 27, 2023

Related U.S. Application Data
(63) Continuation of application No. PCT/JP21/39238, filed on Oct. 25, 2021.

(30) Foreign Application Priority Data
Nov. 6, 2020 (JP) 2020-186048

(51) Int. Cl. G11B 5/65; G11B 5/008

(52) U.S. Cl. CPC G11B 5/653; G11B 5/00813

(57) ABSTRACT

The magnetic tape includes a non-magnetic support; and a magnetic layer containing a ferromagnetic powder, in which, in a small-angle X-ray scattering spectrum obtained by small-angle X-ray scattering measurement of the non-magnetic support, in a region where a q-value is 0.01 to 0.10 Å⁻¹, a ratio Iₘₐₓ/Iₘᵢₙ of a scattering intensity Iₘₐₓ at a q-value qₘₐₓ of a maximal value of a scattering intensity change rate to a scattering intensity Iₘᵢₙ at a q-value qₘᵢₙ of a minimal value of the scattering intensity change rate is 2.7 or more, and qₘᵢₙ<qₘₐₓ is satisfied, and a glass transition temperature Tg of the non-magnetic support is 140° C. or higher.

### CROSS-REFERENCE TO RELATED APPLICATIONS

This application is a Continuation of PCT International Application No. PCT/JP2021/039238 filed on Oct. 25, 2021, which claims priority under 35 U.S.C. § 119(a) to Japanese Patent Application No. 2020-186048 filed on Nov. 6, 2020. Each of the above applications is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic recording and reproducing apparatus.

### 2. Description of the Related Art

A magnetic recording medium usually includes a magnetic layer and a non-magnetic support (see, for example, JP1990-037519A (JP-H2-037519A)).

### SUMMARY OF THE INVENTION

The magnetic recording medium can be either a disk-shaped medium or a tape-shaped medium. JP1990-037519A (JP-H2-037519A) discloses a film used as a non-magnetic support of a disk-shaped magnetic recording medium.

On the other hand, in recent years, a tape-shaped magnetic recording medium, that is, a magnetic tape has been widely used as a magnetic recording medium for data storage such as an archive.

The magnetic tape is usually stored by being accommodated in a magnetic tape cartridge. Specifically, the magnetic tape is usually stored by being wound around a reel of the magnetic tape cartridge in a tensioned state. Because of this tension, deformation of the magnetic tape may occur in the magnetic tape cartridge. It is desirable that such deformation can be suppressed in order to increase reliability of the magnetic tape as a data storage medium. This is for the following reason, for example. Recording of data on the magnetic tape is usually performed by recording a magnetic signal in a data band of the magnetic tape. Thereby, a data track is formed in the data band. On the other hand, in a case of reproducing the recorded data, the magnetic signal recorded on the data track is read by causing a magnetic head to follow the data track of the magnetic tape in a magnetic recording and reproducing apparatus. Here, as an accuracy with which the magnetic head follows the data track is higher, occurrence of a reproduction error can be suppressed, and reliability of the magnetic tape as a data storage medium can be increased. However, in a case where the magnetic tape is greatly deformed after data recording, the accuracy with which the magnetic head follows the data track during data reproduction is reduced, and a reproduction error is likely to occur. For example, for such a reason, it is desirable that deformation of the magnetic tape during storage can be suppressed.

An object of an aspect of the present invention is to provide a magnetic tape capable of suppressing deformation during storage.

One aspect of the present invention relates to a magnetic tape comprising: a non-magnetic support; and a magnetic layer containing a ferromagnetic powder, in which, in a small-angle X-ray scattering spectrum obtained by small-angle X-ray scattering measurement of the non-magnetic support, in a region where a q-value is 0.01 to 0.10 Å⁻¹, a ratio Iₘₐₓ/Iₘᵢₙ of a scattering intensity Iₘₐₓ at a q-value qₘₐₓ of a maximal value of a scattering intensity change rate to a scattering intensity Iₘᵢₙ at a q-value qₘᵢₙ of a minimal value of the scattering intensity change rate is 2.7 or more, and qₘᵢₙ<qₘₐₓ is satisfied, and a glass transition temperature Tg of the non-magnetic support is 140° C. or higher.

In one embodiment, the non-magnetic support may be a support including an aromatic polyether ketone.

In one embodiment, the aromatic polyether ketone may be a polyether ether ketone.

In one embodiment, the aromatic polyether ketone may be a polyether ketone ketone.

In one embodiment, the ferromagnetic powder may be a hexagonal barium ferrite powder.

In one embodiment, the ferromagnetic powder may be a hexagonal strontium ferrite powder.

In one embodiment, the ferromagnetic powder may be an ε-iron oxide powder.

In one embodiment, the magnetic tape may further comprise a non-magnetic layer containing a non-magnetic powder between the non-magnetic support and the magnetic layer.

In one embodiment, the magnetic tape may further comprise a back coating layer containing a non-magnetic powder on a surface side of the non-magnetic support opposite to a surface side having the magnetic layer.

In one embodiment, a center-line average roughness Ra of a surface of the non-magnetic support on a side having the magnetic layer, which is measured by an optical interference roughness meter, may be 15.0 nm or less.

Another aspect of the present invention relates to a magnetic tape cartridge comprising the magnetic tape described above.

Still another aspect of the present invention relates to a magnetic recording and reproducing apparatus comprising the magnetic tape described above.

According to one aspects of the present invention, it is possible to provide a magnetic tape capable of suppressing deformation during storage. In addition, according to one aspect of the present invention, it is possible to provide a magnetic tape cartridge and a magnetic recording and reproducing apparatus which include the magnetic tape.

### DESCRIPTION OF THE PREFERRED EMBODIMENTS

[Magnetic Tape]

One aspect of the present invention relates to a magnetic tape including a non-magnetic support and a magnetic layer containing a ferromagnetic powder. In a small-angle X-ray scattering spectrum obtained by small-angle X-ray scattering measurement of the non-magnetic support, in a region where a q-value is 0.01 to 0.10 Å⁻¹, a ratio Iₘₐₓ/Iₘᵢₙ of a scattering intensity Iₘₐₓ at a q-value qₘₐₓ of a maximal value of a scattering intensity change rate to a scattering intensity Iₘᵢₙ at a q-value qₘᵢₙ of a minimal value of the scattering intensity change rate (hereinafter, also referred to as a “scattering intensity ratio Iₘₐₓ/Iₘᵢₙ”) is 2.7 or more, and qₘᵢₙ<qₘₐₓ is satisfied, and a glass transition temperature Tg of the non-magnetic support is 140° C. or higher.

Hereinafter, the magnetic tape will be described in more detail.

<Non-Magnetic Support>

(Scattering Intensity Ratio Iₘₐₓ/Iₘᵢₙ)

In a small-angle X-ray scattering spectrum obtained by small-angle X-ray scattering measurement of the non-magnetic support (hereinafter, also referred to as a “support”) included in the magnetic tape, in a region where a q-value is 0.01 to 0.10 Å⁻¹, a ratio Iₘₐₓ/Iₘᵢₙ of a scattering intensity Iₘₐₓ at a q-value q max of a maximal value of a scattering intensity change rate to a scattering intensity Iₘᵢₙ at a q-value qₘᵢₙ of a minimal value of the scattering intensity change rate (scattering intensity ratio Iₘₐₓ/Iₘᵢₙ) is 2.7 or more, and qₘᵢₙ<qₘₐₓ is satisfied. Regarding the unit, 1 Å (Angstrom)=0.1 nm.

Hereinafter, a method of obtaining the scattering intensity ratio Iₘₐₓ/Iₘᵢₙ will be described.

(1) Preparation of Sample for Measurement

A plurality of sample pieces are cut out from the non-magnetic support to be measured. A sample piece can be cut out from a support obtained by removing a portion other than the non-magnetic support from the magnetic tape by a well-known method. The direction with respect to the sample piece described below refers to a direction in a case where the sample piece is included in the magnetic tape. The longitudinal direction is a longitudinal direction in the magnetic tape, and the width direction is a width direction in the magnetic tape.

The plurality of cut-out sample pieces are superimposed on each other in the number of pieces (for example, several tens of pieces) with a thickness of 200 μm or more. In the case of the superimposition, the plurality of sample pieces are superimposed on each other such that the longitudinal directions of the plurality of sample pieces are aligned and the width directions thereof are aligned.

A sample piece having a size of several cm in the longitudinal direction×several cm in the width direction is cut out from a laminate in which the plurality of sample pieces are superimposed on each other, and this cut-out sample piece is used as a sample for measurement.

(2) Small-Angle X-Ray Scattering Measurement and Acquisition of Various Spectra

An X-ray is made incident on any one of randomly selected surfaces of the sample for measurement from a direction perpendicular to the surface, a scattered X-ray that has been transmitted through the sample for measurement is detected by a two-dimensional detector, and transmission small-angle X-ray scattering (SAXS) measurement is performed, thereby obtaining an SAXS spectrum. Small-angle X-ray scattering is also generally referred to as “small angle X-ray scattering (SAXS)”. X-ray energy (wavelength λ) is selected in a range of 5 to 20 keV (2.5 to 0.6 Å).

In obtained two-dimensional SAXS intensity distribution data, an average scattering intensity I at each scattering angle 2 θ is obtained on an arc in a range of an azimuthal angle φ ±15° in each of a meridional direction and an equatorial direction, and “2 θ-I one-dimensional SAXS intensity spectrum” is obtained, where a horizontal axis represents 2 θ and a vertical axis is I. The data in the meridional direction is data for the longitudinal direction of the sample piece, and the data in the equatorial direction is data for the width direction of the sample piece. A measurement pitch for obtaining the scattering intensity (that is, an interval between adjacent measurement points) is 0.001 Å⁻¹ or less as a pitch for the following q-value. “I” is used as an abbreviation for “intensity”.

From the “2 θ-I one-dimensional SAXS intensity spectrum”, “q-I one-dimensional SAXS intensity spectrum” is obtained, where a horizontal axis represents the q-value and a vertical axis represents I in a range of a q-value=0.01 to 0.24 Å⁻¹, with respect to the scattering angle 2θ. The q-value is a scattering vector, and q=4π sin θ/λ.

Separately from the above, background SAXS measurement without the sample for measurement is executed with the same integration time as the SAXS measurement with the sample for measurement, to obtain a q-I one-dimensional SAXS intensity spectrum in the same manner as described above. The one-dimensional SAXS intensity spectrum thus obtained is a background q-I one-dimensional SAXS intensity spectrum.

In addition, an incidence X-ray intensity I₀ during the SAXS measurement and a transmitted X-ray intensity I after the transmission of the sample for measurement are measured, and a transmittance T of the X-ray used for the SAXS measurement with respect to the sample for measurement is obtained as “T=I/I₀”.

For the sample for measurement, in the q-I one-dimensional SAXS intensity spectrum obtained in the meridional direction and in the q-I one-dimensional SAXS intensity spectrum obtained in the meridional direction, the q-value at each measurement point is called q, and the scattering intensity at the q-value=q is called “I (q)”, and the q-value at each measurement point in the background q-I one-dimensional SAXS intensity spectrum is called q, and the scattering intensity at the q-value=q is called “I_Bg (q)”. “Bg” is used as an abbreviation for “background”.

For the q-value at each measurement point, “net one-dimensional SAXS intensity spectrum” is obtained, where a vertical axis represents a net scattering intensity (hereinafter, simply referred to as a “scattering intensity”) obtained as a value “I (q)/T−I_Bg (q)” obtained by subtracting I_Bg (q) from a value obtained by dividing I (q) by T, and a horizontal axis represents the q-value. Hereinafter, the “net one-dimensional SAXS intensity spectrum” is referred to as “I_saxs (q)”.

For “I_saxs (q)”, a moving averaging process is performed by performing moving averaging calculation in the order of the q-values. The moving averaging calculation is performed for all the measurement points, and is performed for a total of 11 measurement points adjacent to each other, that is, the middle 1 point and the front (that is, a side with the smaller q-value) 5 points and the rear (that is, a side with the larger q-value) 5 points with respect to the middle 1 point. Note that a total of 10 points, that is, the measurement point with the smallest q-value, the measurement point with the second smallest q-value, the measurement point with the third smallest q-value, the measurement point with the fourth smallest q-value, the measurement point with the fifth smallest q-value, the measurement point with the largest q-value, the measurement point with the second largest q-value, the measurement point with the third largest q-value, the measurement point with the fourth largest q-value, and the measurement point with the fifth largest q-value are excluded from the calculation. Hereinafter, the spectrum thus obtained is referred to as “moving averaging-processed I_saxs (q)”.

It is assumed that the net one-dimensional SAXS intensity spectrum “I_saxs (q)” satisfies the following two conditions.

Condition 1: In a range of “0.20 Å⁻¹≤q≤0.24 Å⁻¹”, a value “Aye/G” obtained by dividing an arithmetic average (Ave) of the scattering intensities of all the measurement points by standard deviation (σ) is defined as a signal-to-noise ratio (SNR), and a SNR value is 3.0 or more. “Ave” is used as an abbreviation for “average”.

Condition 2: In a range of “0.01 Å⁻¹≤q≤0.02 Å⁻¹”, a correlation determination coefficient R² is equal to or more than 0.95 in a case of being fitted by a least square method with an exponential decay function (I=a*exp(−b*q)). In the above relational expression of the exponential decay function, “q” is the q-value in I_saxs (q), and “I” is an approximation function of I_saxs (q) obtained in the fitting process. In addition, “a” and “b” are coefficients determined in the fitting process.

In a case where the net one-dimensional SAXS intensity spectrum “I_saxs (q)” that does not satisfy one or both of the above conditions is obtained, a process, in which one or more of a type of an X-ray source used for the SAXS measurement, the X-ray energy, and the X-ray intensity measuring method for obtaining the transmittance T and the scattered light are changed to obtain the net one-dimensional SAXS intensity spectrum “I_saxs (q)” anew, is repeated until the net one-dimensional SAXS intensity spectrum “I_saxs (q)” that satisfies the above two conditions is obtained.

A first-order differential spectrum is obtained by first-order differentiating the “moving averaging-processed I_saxs (q)” calculated using the net one-dimensional SAXS intensity spectrum “I_saxs (q)” that satisfies the above two conditions, with the q-value. In the first-order differential spectrum, a vertical axis represents the scattering intensity change rate (unitless), and a horizontal axis represents the q-value (unit: Å⁻¹). It is not essential to graph the first-order differential spectrum, for example, tabular data showing the scattering intensity change rate at the q value at each measurement point may be used. This point also applies to various spectra before the first-order differentiation and before and after the moving averaging process.

The first-order differential spectrum is subjected to the moving averaging process through the moving averaging calculation in the order of the q-values. The moving averaging calculation is performed on data composed of a pair of the moving averaging-processed I_saxs (q) and the q-value, which is obtained as data before the first-order differentiation, and is performed on data of a total of 5 points adjacent to each other, that is, the middle 1 point and the front (that is, a side with the smaller q-value) 2 points and the rear (that is, a side with the larger q-value) 2 points with respect to the middle 1 point. Note that data of a total of 4 points, that is, the data with the smallest q-value, the data with the second smallest q-value, the data with the largest q-value, and the data with the second largest q-value are excluded from the calculation. A moving averaging-processed first-order differential spectrum obtained in each of the meridional direction and the equatorial direction is used for obtaining qₘᵢₙ and qₘₐₓ, which will be described below.

(3) Calculation of Scattering Intensity Ratio Iₘₐₓ/Iₘᵢₙ

In the moving averaging-processed first-order differential spectrum obtained in (2) above, the scattering intensity change rate at the measurement point immediately before first change in the scattering intensity change rate on the vertical axis from “negative or 0” to “positive” toward a direction in which the q-value increases from 0.01 Å⁻¹ in a region where the q-value is 0.01 to 0.10 Å⁻¹ is defined as “a minimal value Vₘᵢₙ of a scattering intensity change rate”, and the q-value taking the minimal value Vₘᵢₙ is defined as “qₘᵢₙ”. Further, the scattering intensity change rate at the measurement point immediately after first change in the scattering intensity change rate on the vertical axis from “positive” to “negative or 0” toward a direction in which the q-value increases in a region where the q-value is larger than qₘᵢₙ is defined as “a maximal value Vₘₐₓ of a scattering intensity change rate”, and the q-value taking the maximal value Vₘₐₓ is defined as “qₘₐₓ”. Therefore, qₘᵢₙ<qₘₐₓ. “V” is used as an abbreviation for “variation (rate of change)”, “min” is used as an abbreviation for “local minimum (minimal)”, and “max” is used as an abbreviation for “local maximum (maximal)”.

For the moving averaging-processed I_saxs (q) before the first-order differentiation is executed, a ratio (Iₘₐₓ/Iₘᵢₙ) of the scattering intensity Iₘₐₓ at qₘₐₓ to the scattering intensity Iₘᵢₙ at qₘᵢₙ obtained as described above in each of the meridional direction and the equatorial direction is obtained. The arithmetic average of the ratios (Iₘₐₓ/Iₘᵢₙ) thus obtained in each of the both directions is defined as the scattering intensity ratio Iₘₐₓ/Iₘᵢₙ of the non-magnetic support to be measured.

The non-magnetic support included in the magnetic tape has a scattering intensity ratio Iₘₐₓ/Iₘᵢₙ of 2.7 or more, which is obtained as described above. The present inventor considers that the scattering intensity ratio Iₘₐₓ/Iₘᵢₙ is a value that can be an index of an arrangement state of crystal portions included in the non-magnetic support. The crystal portion can be said to be a region in which polymer chains are regularly arranged, and may be a region that is harder than an amorphous portion. In a case where such crystal portions have a certain size and the crystal portions are distributed with regularity, it is supposed that the value of the scattering intensity ratio Iₘₐₓ/Iₘᵢₙ becomes large. It is considered that the non-magnetic support in which the crystal portion is present in a state where the value of the scattering intensity ratio Iₘₐₓ/Iₘᵢₙ is 2.7 or more has high hardness and has excellent resistance to deformation during storage. From the viewpoint of further suppressing the deformation of the magnetic tape during storage, the scattering intensity ratio Iₘₐₓ/Iₘᵢₙ of the non-magnetic support is preferably 2.8 or more, and more preferably 2.9 or more. In addition, the scattering intensity ratio Iₘₐₓ/Iₘᵢₙ of the non-magnetic support may be, for example, 20.0 or less, 15.0 or less, or 10.0 or less, or may exceed values exemplified here. The scattering intensity ratio can be controlled, for example, by manufacturing conditions of the non-magnetic support. This point will be described below.

(Glass Transition Temperature Tg)

A glass transition temperature Tg of the non-magnetic support included in the magnetic tape is 140° C. or higher. The present inventor considers that this also contributes to suppression of the deformation of the magnetic tape during storage. It is considered that the non-magnetic support having a high glass transition temperature Tg of 140° C. or higher has a strong binding force between the polymer chains contained in the non-magnetic support, which may lead to increase in the resistance to the deformation during storage. From the viewpoint of further still suppressing the deformation of the magnetic tape during storage, the glass transition temperature Tg of the non-magnetic support is preferably 142° C. or higher, more preferably 145° C. or higher, and still more preferably 150° C. or higher. In addition, the glass transition temperature Tg of the non-magnetic support may be, for example, 180° C. or lower, 175° C. or lower, 170° C. or lower, or 165° C. or lower, or may exceed values exemplified here. The glass transition temperature of the non-magnetic support may depend, for example, on a type of a resin constituting the non-magnetic support. The resin that can constitute the non-magnetic support will be described below.

The glass transition temperature Tg of the non-magnetic support in the present invention and the present specification is obtained in accordance with JIS K 7121-1987 “Method for measuring transition temperature of plastic”, and specifically, it is set to a value measured by the following method.

A sample piece is cut out from the non-magnetic support to be measured. A sample piece can be cut out from a support obtained by removing a portion other than the non-magnetic support from the magnetic tape by a well-known method.

The glass transition temperature Tg is measured by a differential scanning calorimetry (DSC). As the DSC, for example, a Q100 type manufactured by TA instruments can be used.

The sample piece is placed in an environment of an atmosphere temperature of 23±2° C. and a relative humidity of 50±5% for 24 hours or more, and then the sample piece is set in the DSC and the temperature is raised and lowered twice as follows. Using a DSC profile obtained in the second temperature raising, an extrapolated glass transition starting temperature (“Tig” in JIS) according to item 9.3 (2) of JIS K 7121-1987 “Method for measuring transition temperature of plastic” is obtained, and the obtained temperature is defined as the glass transition temperature Tg.
(First Raising and Lowering of Temperature)
Temperature raising: Raising the temperature to 300° C. and holding for 10 minutes
Temperature lowering: Cooling to 25° C.
Temperature rising rate: 10° C./min
Temperature lowering rate: 5° C./min
Nitrogen gas flow rate in measurement: 50 ml/min
(Second Raising and Lowering of Temperature)
Temperature raising: Raising the temperature to 300° C. and holding for 10 minutes
Temperature lowering: Optional
Temperature rising rate: 10° C./min
Temperature lowering rate: Optional
Nitrogen gas flow rate in measurement: 50 ml/min

As described above, the present invention considers that the fact that the scattering intensity ratio Iₘₐₓ/Iₘᵢₙ is 2.7 or more and the glass transition temperature is 140° C. or more can contribute to the suppression of the deformation of the magnetic tape during storage. For the magnetic tape, in recent years, there has been an increasing need for a magnetic tape that can withstand use in an environment where the deformation is more likely to occur (for example, an environment of higher temperature and higher humidity). In addition, as the capacity is increased, the number of tracks is increased and the track density is increased, so that, in a case where the magnetic tape is deformed, a reproduction error is more likely to occur. Under such a situation, a demand for suppressing the deformation of the magnetic tape has become more stringent. The magnetic tape can be a magnetic tape that can withstand a stringent demand for suppressing such deformation.

(Center-Line Average Roughness Ra)

Excellent surface smoothness of the magnetic layer of the magnetic tape leads to reduction in spacing loss, and can contribute to improvement in electromagnetic conversion characteristics. From the viewpoint of forming the magnetic layer having excellent surface smoothness, it is preferable that the surface smoothness on a side of the non-magnetic support having the magnetic layer is high. From this point of view, in the non-magnetic support included in the magnetic tape, a center-line average roughness of the surface on the side having the magnetic layer is preferably 15.0 nm or less, more preferably 12.0 nm or less, and still more preferably 10.0 nm or less, as measured by an optical interference roughness meter. On the other hand, from the viewpoint of ease of handling of the non-magnetic support during the manufacturing of the magnetic tape, in the non-magnetic support included in the magnetic tape, the center-line average roughness Ra of the surface on the side having the magnetic layer is preferably 0.1 nm or more, more preferably 0.15 nm or more, still more preferably 0.2 nm or more, and still more preferably 0.3 nm or more, as measured by an optical interference roughness meter.

The center-line average roughness Ra in the present invention and the present specification is a value obtained through the measurement with an optical interference roughness meter. Specifically, using an objective lens having a magnification of 20× and a zoom lens having a magnification of 1×, measurement is performed in a region having a size of a long side of 340 to 360 μm×a short side of 250 to 270 μm on a surface to be measured, and after the measurement, filter processing is performed such that a wavelength component of 1.65 μm or less and a wavelength component of 50 μm or more are removed, and further, distortion is removed with cylinder filter to obtain a Ra value. As the optical interference roughness meter, for example, a newview 6300 type manufactured by Zygo Corporation can be used, and software metropro 8.3.5 for the same optical interference roughness meter can be used for the filter processing. For the center-line average roughness Ra of the surface of the non-magnetic support, the surface of the non-magnetic support can be exposed by removing a layer laminated on the magnetic layer side of the non-magnetic support from the magnetic tape by a well-known method, and the center-line average roughness Ra can be obtained for this surface.

(Type of Non-Magnetic Support)

The non-magnetic support included in the magnetic tape can be a support including a resin film. It is preferable that the resin is of a type of a resin capable of manufacturing a support having a glass transition temperature Tg of 140° C. or higher. From this point of view, it is preferable that the non-magnetic support is a support including an aromatic polyether ketone. In the present invention and the present specification, the term “aromatic polyether ketone” refers to a resin having a plurality of partial structures in which an ether bond, a phenylene group, and a ketone bond are linked in the order of “ether bond-phenylene group-ketone bond-phenylene group”. In the above, “-” indicates that they are directly bonded. A bonding position of the above-mentioned bond to each phenylene group is independently at any of a para-position, an ortho-position, or a meta-position, and can be, for example, a para-position. The plurality of phenylene groups included in the partial structure can each independently an unsubstituted phenylene group or a substituted phenylene group. The above points are the same for various aromatic polyether ketones described below. The term “aromatic polyether ketone” in the present invention and the present specification includes those in which repeating units constituting the resin are composed only of the above-described partial structures and those including the above-described partial structures and another partial structure. The term “support including aromatic polyether ketone” means a support including at least one layer of an aromatic polyether ketone film. The term “aromatic polyether ketone film” refers to a film in which a component that accounts for the largest amount on a mass basis among components constituting the film is an aromatic polyether ketone. The term “support including aromatic polyether ketone” in the present invention and the present specification includes those in which all resin films included in the support are aromatic polyether ketone films, and those including the aromatic polyether ketone film and another resin film. Specific forms of the aromatic polyether film support include a single-layer aromatic polyether ketone film, a laminated film of two or more aromatic polyether ketone films having the same constituent components, a laminated film of two or more aromatic polyether ketone films having different constituent components, a laminated film including one or more aromatic polyether ketone films and one or more resin films other than the aromatic polyether ketone, and the like. An adhesive layer or the like may be optionally included between two adjacent layers in the laminated film. The support including aromatic polyether ketone may optionally include a metal film and/or a metal oxide film formed on one or both surfaces by vapor deposition or the like. As the aromatic polyether ketone, polyether ketone (PEK) in which an ether bond and a ketone bond are alternately included via a phenylene group; polyether ether ketone (PEEK) in which an ether bond and a ketone bond are included in the order of “ether bond, ether bond, and ketone bond” via a phenylene group; polyether ketone ketone (PEKK) in which an ether bond and a ketone bond are included in the order of “ether bond, ketone bond, and ketone bond” via a phenylene group; polyether ether ketone ketone (PEEKK) in which an ether bond and a ketone bond are included in the order of “ether bond, ether bond, ketone bond, and ketone bond” via a phenylene group; and polyether ketone ether ketone ketone (PEKEKK) in which an ether bond and a ketone bond are included in the order of “ether bond, ketone bond, ether bond, ketone bond, and ketone bond” via a phenylene group, and polyether ether ketone and polyether ketone ketone are preferred. Specifically, the polyether ether ketone (PEEK) is a resin having a plurality of partial structures in which an ether bond, a phenylene group, and a ketone bond are linked in the order of “ether bond-phenylene group-ether bond-phenylene group-ketone bond-phenylene group”. The term “polyether ether ketone” in the present invention and the present specification includes those in which repeating units constituting the resin are composed only of the above-described partial structures and those including the above-described partial structures and another partial structure. The polyether ketone ketone (PEKK) is a resin having a plurality of partial structures in which an ether bond, a phenylene group, and a ketone bond are linked in the order of “ether bond-phenylene group-ketone bond-phenylene group-ketone bond-phenylene group”. The term “polyether ketone ketone” in the present invention and the present specification includes those in which repeating units constituting the resin are composed only of the above-described partial structures and those including the above-described partial structures and another partial structure.

(Manufacturing Method of Non-Magnetic Support)

The non-magnetic support included in the magnetic tape can be manufactured, for example, through a manufacturing step including a step of performing a stretching treatment on a commercially available resin film or a resin film manufactured by a well-known method. The stretching treatment for stretching the film in two directions, the longitudinal direction and the width direction, is biaxial stretching. The stretching in the longitudinal direction and the stretching in the width direction can be performed simultaneously or sequentially. The longitudinal direction of the non-magnetic support is a machine direction (MD direction) in a case of manufacturing a support original roll, and the width direction of the non-magnetic support is a transverse direction (TD direction) in a case of manufacturing the support original roll. The MD direction is a traveling direction of the support original roll in the case of manufacturing the original roll of the support, and the TD direction is a direction orthogonal to the MD direction. A stretching ratio is preferably 2.6 times or more, and more preferably 2.8 times or more, in each of the longitudinal direction and the width direction. The stretching ratio is a magnification of the dimensions after the stretching treatment with respect to the dimensions before the stretching treatment. From the viewpoint of suppressing reduction in surface smoothness of the support due to crystal precipitation, the stretching ratio is preferably 6.0 times or less in each of the longitudinal direction and the width direction, and is more preferably 3.3 times or less in view of suppressing occurrence of breakage and stably performing the stretching. A stretching temperature may be, for example, 150° C. or higher or 155° C. or higher. From the viewpoint of suppressing reduction in surface smoothness of the support due to crystal precipitation, the stretching temperature is preferably 175° C. or lower, more preferably 170° C. or lower, and still more preferably 165° C. or lower. Here, the term “stretching temperature” refers to an atmosphere temperature of an environment in which the stretching treatment is performed. A stretching rate in the stretching treatment may be, for example, in a range of 10 to 90000%/min, and is preferably in a range of 20 to 10000%/min, and more preferably in a range of 50 to 3000%/min. The stretching rate is a value obtained by dividing ((dimensions after stretching treatment/dimensions before stretching treatment)−1)×100 (unit: %) by a stretching treatment time (unit: minutes).

A well-known post-treatment can be optionally applied to the resin film after the stretching treatment. Specific examples of the post-treatment include a heat treatment. The heat treatment can be performed, for example, by holding the resin film after the stretching treatment in an environment of an atmosphere temperature equal to or higher than the stretching temperature. The heat treatment temperature is, for example, preferably equal to or lower than a temperature equal to or higher than the stretching temperature and lower than a melting point of the resin film by 10° C., and more preferably equal to or lower than a temperature equal to or higher than the stretching temperature and lower than the melting point of the resin film by 20° C. The melting point can be measured according to a measuring method of a melting peak temperature according to JIS K 7121-1987. The heat treatment can contribute to immobilizing the alignment state of the polymer chains of the resin aligned by the stretching treatment. A relaxation rate in the heat treatment may be 0.80 times or more and less than 1.00 time in each of the longitudinal direction and the width direction. The relaxation rate is a magnification of the dimensions after the heat treatment with respect to the dimensions before the heat treatment.

The non-magnetic support may be subjected to one or more treatments such as a corona discharge, a plasma treatment, and an easy-bonding treatment before a layer such as a magnetic layer is formed thereon.

<Magnetic Layer>

(Ferromagnetic Powder)

A magnetic layer contains a ferromagnetic powder. As a ferromagnetic powder contained in the magnetic layer, a well-known ferromagnetic powder as a ferromagnetic powder used in magnetic layers of various magnetic recording media can be used. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, and still more preferably 25 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite type crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite type crystal structure in an X-ray diffraction spectrum obtained by X-ray diffraction analysis, it is determined that the hexagonal ferrite type crystal structure is detected as the main phase. In a case where only a single structure is detected by X-ray diffraction analysis, this detected structure is taken as the main phase. The hexagonal ferrite type crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

An activation volume of the hexagonal strontium ferrite powder is preferably in a range of 800 to 1500 nm³. The finely granulated hexagonal strontium ferrite powder having an activation volume in the above range is suitable for manufacturing a magnetic tape exhibiting excellent electromagnetic conversion characteristics. The activation volume of the hexagonal strontium ferrite powder is preferably 800 nm³ or more, and may be, for example, 850 nm³ or more. From the viewpoint of further improving the electromagnetic conversion characteristics, the activation volume of the hexagonal strontium ferrite powder is more preferably 1400 nm³ or less, still more preferably 1300 nm³ or less, still more preferably 1200 nm³ or less, and still more preferably 1100 nm³ or less.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample fluxmeter (measurement temperature: 23° C.±1° C.). For a unit of the anisotropy constant Ku, 1 erg/cc=1.0×10⁻¹ J/m³.

Hc=2Ku/Ms{1−[(kT/KuV)In(At/0.693)]^{1/2}}

[In the above expression, Ku: anisotropy constant (unit: J/m³), Ms: saturation magnetization (unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in the case of including two or more types of rare earth atoms is obtained for the total of two or more types of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 ml of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 ml of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample fluxmeter, capable of measuring magnetic properties. In the present invention and the present specification, unless otherwise noted, the mass magnetization σs is a value measured at a magnetic field intensity of 1194 kA/m (15 kOe).

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder can also include one or more kinds of other divalent metal atoms, in addition to the strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M type crystal structure may be detected by X-ray diffraction analysis. For example, M type hexagonal ferrite is represented by a composition formula of AFei2019. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

ε-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide type crystal structure is detected as a main phase by X-ray diffraction analysis. For example, in a case where the highest intensity diffraction peak is attributed to an ε-iron oxide type crystal structure in an X-ray diffraction spectrum obtained by X-ray diffraction analysis, it is determined that the ε-iron oxide type crystal structure is detected as the main phase. As a method of manufacturing an ε-iron oxide powder, a manufacturing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. 51, pp. 5280 to 5284, J. Mater. Chem. C, 2013, 1, pp. 5200 to 5206 can be referred to, for example. Note that the method of manufacturing the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10⁴ J/m³ or more. Ku of the 8-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in one aspect, σs of the ε-iron oxide powder may be 8 A·m²/kg or more, and may be 12 A·m²/kg or more. On the other hand, from the viewpoint of noise reduction, σs of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably 50 to 90 mass % and more preferably 60 to 90 mass %. A high filling percentage of the ferromagnetic powder in the magnetic layer is preferable from the viewpoint of improving the recording density.

(Binding Agent)

The magnetic tape can be a coating type magnetic tape and can include the binding agent in the magnetic layer. The binding agent is one or more kinds of resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A and paragraphs 0006 to 0021 of JP2004-5795A can be referred to. An average molecular weight of the resin used as the binding agent can be, for example, 10,000 to 200,000 as a weight-average molecular weight. The average molecular weight of the present invention and the present specification is a value obtained by performing polystyrene conversion of a value measured by gel permeation chromatography (GPC) under the following measurement conditions. The average molecular weight of the binding agent shown in Examples described below is a value obtained by performing polystyrene conversion of a value measured under the following measurement conditions. The binding agent may be used in an amount of, for example, 1.0 to 80.0 parts by mass with respect to 100.0 parts by mass of the ferromagnetic powder. For the amount of the binding agent in the non-magnetic layer and the back coating layer, the description regarding the amount of the binding agent in the magnetic layer can be applied by replacing the ferromagnetic powder with the non-magnetic powder.
GPC device: HLC-8120 (manufactured by Tosoh Corporation)
Column: TSKgel Multipore HXL-M (manufactured by Tosoh Corporation, 7.8 mm inner diameter (ID)×30.0 cm)
Eluent: tetrahydrofuran (THF)

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The content of the curing agent in a magnetic layer forming composition may be, for example, 0 to 80.0 parts by mass, and from the viewpoint of improving a strength of the magnetic layer, may be 50.0 to 80.0 parts by mass, with respect to 100.0 parts by mass of the binding agent. The same applies to a non-magnetic layer forming composition and a back coating layer forming composition.

(Additive)

The magnetic layer may include one or more kinds of additives, as necessary. As the additives, the curing agent described above is used as an example. In addition, examples of the additive which can be included in the magnetic layer include a non-magnetic powder (for example, an inorganic powder or carbon black), a lubricant, a dispersing agent, a dispersing assistant, an antibacterial agent, an antistatic agent, an antioxidant, and the like. For example, for the lubricant, descriptions disclosed in paragraphs 0030 to 0033, 0035, and 0036 of JP2016-126817A can be referred to. The non-magnetic layer which will be described below may include a lubricant. For the lubricant that can be included in the non-magnetic layer, descriptions disclosed in paragraphs 0030, 0031, 0034, 0035, and 0036 of JP2016-126817A can be referred to. For the dispersing agent, descriptions disclosed in paragraphs 0061 and 0071 of JP2012-133837A can be referred to. For the additive of the magnetic layer, descriptions disclosed in paragraphs 0035 to 0077 of JP2016-51493A can be referred to. The dispersing agent may be added to a non-magnetic layer forming composition. For the dispersing agent that can be added to the non-magnetic layer forming composition, a description disclosed in a paragraph 0061 of JP2012-133837A can be referred to. As the non-magnetic powder that can be included in the magnetic layer, a non-magnetic powder which can function as an abrasive, or a non-magnetic powder which can function as a protrusion forming agent which forms protrusions appropriately protruded from the magnetic layer surface (for example, non-magnetic colloidal particles) is used. An average particle size of colloidal silica (silica colloidal particles) shown in Examples described below is a value obtained by a method disclosed as a measurement method of an average particle diameter in a paragraph 0015 of JP2011-048878A. As the additive, a commercially available product can be suitably selected or manufactured by a well-known method according to the desired properties, and any amount thereof can be used. As an example of the additive which can be used for improving dispersibility of the abrasive in the magnetic layer including the abrasive, a dispersing agent disclosed in paragraphs 0012 to 0022 of JP2013-131285A can be used.

As described above, the high surface smoothness of the magnetic layer of the magnetic tape can contribute to the improvement of the electromagnetic conversion characteristics. From the viewpoint of improving the electromagnetic conversion characteristics, the center-line average roughness Ra of the surface of the magnetic layer of magnetic tape is preferably 4.0 nm or less, more preferably 3.8 nm or less, and still more preferably 3.7 nm or less, as measured by the optical interference roughness meter. In the present invention and the present specification, the term “magnetic layer surface (surface of the magnetic layer)” of the magnetic tape has the same meaning as the surface of the magnetic tape on the magnetic layer side. In addition, from the viewpoint of improving the running stability, the center-line average roughness Ra of the surface of the magnetic layer of magnetic tape is preferably 0.3 nm or more, and more preferably 0.5 nm or more, as measured by the optical interference roughness meter.

The magnetic layer described above can be provided on a surface of the non-magnetic support directly or indirectly through the non-magnetic layer.

<Non-Magnetic Layer>

Next, the non-magnetic layer will be described. The above magnetic tape may have a magnetic layer directly on the surface of the non-magnetic support, or may have a magnetic layer on the surface of the non-magnetic support through a non-magnetic layer containing a non-magnetic powder. The non-magnetic powder used in the non-magnetic layer may be an inorganic powder or an organic powder. In addition, the carbon black and the like can be used. Examples of the inorganic powder include powders of metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably 50 to 90 mass % and more preferably 60 to 90 mass %.

In regards to other details of a binding agent or an additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The non-magnetic layer of the present invention and the present specification also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and coercivity.

<Back Coating Layer>

The magnetic tape may or may not have a back coating layer including a non-magnetic powder on a surface side of the non-magnetic support opposite to a surface side having the magnetic layer. The back coating layer preferably contains any one or both of carbon black and an inorganic powder. As the carbon black, for example, carbon black having an average particle size of 17 nm or more and 50 nm or less (hereinafter, referred to as “fine particle carbon black”) can be used, and carbon black having an average particle size of more than 50 nm and 300 nm or less (hereinafter, referred to as “coarse particle carbon black”) can be used. Further, fine particle carbon black and coarse particle carbon black can be used in combination.

Examples of the inorganic powder include a non-magnetic powder generally used for the non-magnetic layer and a non-magnetic powder generally used as an abrasive for the magnetic layer, and among them, α-iron oxide, α-alumina, and the like are preferable. The average particle size of the inorganic powder in the back coating layer may be, for example, in a range of 5 to 250 nm. In a case where the carbon black and the inorganic powder are used in combination as the non-magnetic powder of the back coating layer, in one aspect, the inorganic powder is preferably included in an amount of more than 50.0 parts by mass, and more preferably included in an amount of 70.0 to 90.0 parts by mass, with respect to the total amount of the non-magnetic powder of 100.0 parts by mass. In one aspect, the description regarding the non-magnetic powder of the back coating layer can be applied to the non-magnetic powder of the non-magnetic layer.

The back coating layer can include a binding agent, and can also include an additive, as necessary. Regarding the binding agent and additive in the back coating layer, a well-known technology for the back coating layer can be applied, and a well-known technology for the formulation of the magnetic layer and/or the non-magnetic layer can also be applied. For example, for the back coating layer, descriptions disclosed in paragraphs 0018 to 0020 of JP2006-331625A and page 4, line 65, to page 5, line 38, of U.S. Pat. No. 7,029,774B can be referred to.

<Various Thicknesses>

A thin thickness of the magnetic tape is preferable from the viewpoint of increasing the capacity of one roll of a magnetic tape cartridge. Reducing a thickness of the non-magnetic support is preferable because it may lead to reduction in thickness of the magnetic tape. From this point, the thickness of the non-magnetic support included in the magnetic tape is preferably less than 10.0 μm, more preferably 9.0 μm or less, still more preferably 8.0 μm or less, still more preferably 7.0 μm or less, and still more preferably 6.0 μm or less. Further, the thickness of the non-magnetic support may be, for example, 0.5 μm or more or 1.0 μm or more.

A thickness of the magnetic layer can be optimized according to a saturation magnetization amount, a head gap length, and a band of a recording signal of the used magnetic head, is generally 0.01 μm to 0.15 μm, and, from the viewpoint of high-density recording, is preferably 0.015 μm to 0.12 μm and more preferably 0.02 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less and more preferably 0.1 to 0.7 μm.

The thickness of the non-magnetic support and the thickness of each layer in the present invention and the present specification can be obtained by a well-known method. For example, the thickness of the magnetic layer can be obtained by the following method. After exposing a cross section of the magnetic tape in a thickness direction by a well-known method such as an ion beam or a microtome, a cross section image of the exposed cross section is acquired by a scanning electron microscope (SEM) or a transmission electron microscope (TEM). Cross section images are acquired for ten randomly selected locations. A thickness of the magnetic layer is measured at one location randomly selected from each of the ten images acquired in this way. In this way, a thickness of the magnetic layer can be obtained as an arithmetic average of ten measurement values obtained for ten images. In a case of obtaining a thickness of the magnetic layer, an interface between the magnetic layer and an adjacent portion (for example, the non-magnetic layer) can be specified by a method disclosed in a paragraph 0029 of JP2017-33617A. Other thicknesses can be obtained in the same manner.

<Manufacturing Step>

(Preparation of Each Layer Forming Composition)

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of each layer forming composition may be added at an initial stage or in a middle stage of each step. As a solvent, one kind or two or more kinds of various solvents generally used for manufacturing a coating type magnetic recording medium can be used. For the solvent, for example, a description disclosed in a paragraph 0153 of JP2011-216149A can be referred to. In addition, each component may be separately added in two or more steps. For example, a binding agent may be added separately in a kneading step, a dispersing step, and a mixing step for adjusting a viscosity after dispersion. In order to manufacture the magnetic tape, a well-known manufacturing technology can be used in various steps. In the kneading step, an open kneader, it is preferable to use a continuous kneader, a pressure kneader, or a kneader having a strong kneading force such as an extruder. For details of the kneading treatment, descriptions disclosed in JP1989-106338A (JP-H1-106338A) and JP1989-79274A (JP-H01-79274A) can be referred to. As a disperser, a well-known disperser can be used. In any stage of preparing each layer forming composition, filtering may be performed by a well-known method. The filtering can be performed by using a filter, for example. As the filter used in the filtering, a filter having a pore diameter of 0.01 to 3 μm (for example, a filter made of glass fiber or a filter made of polypropylene) can be used, for example.

(Coating Step)

The magnetic layer can be formed by directly applying the magnetic layer forming composition onto the non-magnetic support surface or performing multilayer applying of the magnetic layer forming composition with the non-magnetic layer forming composition sequentially or simultaneously. The back coating layer can be formed by applying a back coating layer forming composition onto a surface of the non-magnetic support opposite to a surface having the non-magnetic layer and/or the magnetic layer (or to be provided with the non-magnetic layer and/or the magnetic layer). For details of the coating for forming each layer, a description disclosed in a paragraph 0066 of JP2010-231843A can be referred to.

(Other Steps)

Well-known technologies can be applied to other various steps for manufacturing the magnetic tape. Regarding the various steps, the descriptions disclosed in paragraphs 0067 to 0070 of JP2010-231843A can be referred to, for example. For example, a coating layer of the magnetic layer forming composition can be subjected to an alignment treatment while the coating layer is in a wet (undried) state. For the alignment treatment, the various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone.

Through various steps, a long magnetic tape original roll can be obtained. The obtained magnetic tape original roll is cut (slit) by a well-known cutter to have a width of the magnetic tape to be wound around the magnetic tape cartridge. The width is determined according to the standard and is, for example, ½ inches. 1 inch is 0.0254 meters.

It is possible to form a servo pattern in the manufactured magnetic tape by a well-known method in order to enable tracking control of the magnetic head in the magnetic recording and reproducing apparatus, control of a running speed of the magnetic tape, and the like. The term “formation of servo pattern” can also be referred to as “recording of servo signal”. The formation of the servo pattern will be described below.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) standard (generally called “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. The servo system is a system that performs head tracking using servo signals. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

In a method of uniquely specifying the servo band, a staggered method as shown in ECMA-319 (June 2001) is used. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

The magnetic tape is usually accommodated in a magnetic tape cartridge.

[Magnetic Tape Cartridge]

Another aspect of the present invention relates to a magnetic tape cartridge comprising the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing apparatus for recording and/or reproducing data on the magnetic tape, the magnetic tape is pulled out of the magnetic tape cartridge to be wound around the reel on the magnetic recording and reproducing apparatus side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing apparatus side. During this time, for example, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be either a single reel type or dual reel type magnetic tape cartridge. The above magnetic tape cartridge need only include the magnetic tape according to one aspect of the present invention, and the well-known technology can be applied to the others.

[Magnetic Recording and Reproducing Apparatus]

Still another aspect of the present invention relates to a magnetic recording and reproducing apparatus comprising the magnetic tape described above.

In the present invention and the present specification, the term “magnetic recording and reproducing apparatus” means an apparatus capable of performing at least one of the recording of data on the magnetic tape or the reproduction of data recorded on the magnetic tape. Such an apparatus is generally called a drive. The magnetic recording and reproducing apparatus can be, for example, a sliding type magnetic recording and reproducing apparatus. The sliding type magnetic recording and reproducing apparatus is an apparatus in which the surface of the magnetic layer and the magnetic head come into contact with each other to be slid on each other, in a case of performing the recording of data on the magnetic tape and/or reproducing of the recorded data. For example, the magnetic recording and reproducing apparatus can attachably and detachably include the magnetic tape cartridge.

The magnetic recording and reproducing apparatus can include a magnetic head. The magnetic head can be a recording head capable of performing the recording of data on the magnetic tape, or can be a reproducing head capable of performing the reproducing of data recorded on the magnetic tape. In addition, in one aspect, the magnetic recording and reproducing apparatus can include both a recording head and a reproducing head as separate magnetic heads. In another aspect, the magnetic head included in the magnetic recording and reproducing apparatus can have a configuration in which both an element for recording data (recording element) and an element for reproducing data (reproducing element) are included in one magnetic head. Hereinafter, the element for recording and the element for reproducing data are collectively referred to as an “element for data”. As the reproducing head, a magnetic head (MR head) including a magnetoresistive (MR) element capable of sensitively reading data recorded on the magnetic tape as a reproducing element is preferable. As the MR head, various well-known MR heads such as an anisotropic magnetoresistive (AMR) head, a giant magnetoresistive (GMR) head, and a tunnel magnetoresistive (TMR) head can be used. In addition, the magnetic head which performs the recording of data and/or the reproduction of data may include a servo signal reading element. Alternatively, as a head other than the magnetic head which performs the recording of data and/or the reproduction of data, a magnetic head (servo head) comprising a servo signal reading element may be included in the magnetic recording and reproducing apparatus. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing apparatus, recording of data on the magnetic tape and/or reproduction of data recorded on the magnetic tape can be performed, for example, as the magnetic layer surface of the magnetic tape and the magnetic head come into contact with each other to be slid on each other. The magnetic recording and reproducing apparatus need only include the magnetic tape according to one aspect of the present invention, and the well-known technology can be applied to the others.

For example, in a case of recording data and/or reproducing recorded data, first, tracking using the servo signal is performed. That is, by causing the servo signal reading element to follow a predetermined servo track, the element for data is controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, the present invention will be described in more detail with reference to Examples. Note that the present invention is not limited to aspects shown in Examples. “Parts” and “%” in the following description mean “parts by mass” and “mass %”, unless otherwise noted. “eq” is an equivalent and is a unit that cannot be converted into an SI unit. The following steps and evaluations were performed in air at 23° C.±1° C., unless otherwise noted.

[Non-Magnetic Support]

A support described as “PEEK” in the row of “Resin” in Table 1 was manufactured by the following method.

A commercially available PEEK film (Aptiv film 1000 manufactured by Victrex plc.) was cut to have a size of 165 mm×115 mm, attached to a batch type simultaneous biaxial stretching device, and subjected to a stretching treatment at the stretching temperature, stretching ratio, and stretching rate shown in Table 1.

Next, a heat treatment was performed at a relaxation rate of 0.95 times in a heating furnace having an atmosphere temperature in the furnace of 300° C.

The stretched film thus obtained was cut to have a width of ½ inches, and a piece cut out to have a width of ½ inches from a commercially available polyethylene terephthalate film was bonded to both ends thereof to manufacture a support original roll. A magnetic tape original roll was manufactured by the method described below using this support original roll. As the magnetic tape to be evaluated for evaluation described below, a magnetic tape obtained by cutting out a portion where a support portion is a PEEK film from the manufactured magnetic tape original roll was used.

A support described as “PEKK” in the row of “Resin” in Table 1 was manufactured by the following method.

A polyether ketone ketone (glass transition temperature: 162° C., melting point: 331° C.) in which the repeating units constituting the resin are composed only of repeating units of the following structural formula was used, melted and kneaded in an extruder, extruded from a T-die at a resin temperature of 390° C., and cooled to obtain a film.

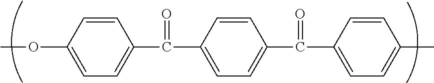

Prior to the extrusion, a foreign matter (undissolved resin, supposed to be resin with excessive cross-linking) was removed through a filtration treatment. This film was cut to have a size of 165 mm×115 mm, attached to a batch type simultaneous biaxial stretching device, and subjected to a stretching treatment at the stretching temperature, stretching ratio, and stretching rate shown in Table 1.

Next, a heat treatment was performed at a relaxation rate of 0.95 times in a heat treatment furnace having an atmosphere temperature in the furnace of 300° C.

The stretched film thus obtained was cut to have a width of ½ inches, and a piece cut out to have a width of ½ inches from a commercially available biaxially stretched polyethylene terephthalate film was bonded to both ends thereof to manufacture a support original roll. A magnetic tape original roll was manufactured by the method described below using this support original roll. As the magnetic tape to be evaluated for evaluation described below, a magnetic tape obtained by cutting out a portion where a support portion is a PEKK film from the manufactured magnetic tape original roll was used.

As a support described as “PEEK” in the row of “Resin” and described as “None” in the row of “stretching ratio” in Table 1, a film cut out to have a width of ½ inches and a length appropriate for being used for manufacturing the magnetic tape original roll from a commercially available PEEK film (Aptiv film 1000 manufactured by Victrex plc.) was used without the stretching treatment or the heat treatment.

A support described as “PET” in the row of “Resin” in Table 1 is a support cut out to have a width of ½ inches and a length appropriate for being used for manufacturing the magnetic tape original roll from a commercially available biaxially stretched polyethylene terephthelate film.

A support described as “PEN” in the row of “Resin” in Table 1 is a support cut out to have a width of ½ inches and a length appropriate for being used for manufacturing the magnetic tape original roll from a commercially available biaxially stretched polyethylene naphthalate film.

A support described as “aromatic polyamide” in the row of “Resin” in Table 1 is a support cut out to have a width of ½ inches and a length appropriate for being used for manufacturing the magnetic tape original roll from a commercially available biaxially stretched aromatic polyamide film.

### Example 1

(1) Preparation of Alumina Dispersion

3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an alumina powder (HIT-80 manufactured by Sumitomo Chemical Co., Ltd.) having a pregelatinization ratio of about 65% and a Brunauer-Emmett-Teller (BET) specific surface area of 20 m²/g, and dispersed in the presence of zirconia beads by a paint shaker for 5 hours. After the dispersion, the dispersion liquid and the beads were separated by a mesh and an alumina dispersion was obtained.

(2) Formulation of Magnetic Layer Forming Composition

| (Magnetic Liquid) | | |
|---|---|---|
| Ferromagnetic powder | 100.0 | parts |
| Hexagonal barium ferrite powder having average particle | | |
| size (average plate diameter) of 21 nm (“BaFe” in Table 1) | | |
| SO₃Na group-containing polyurethane resin | 14.0 | parts |
| Weight-average molecular weight: 70,000, SO₃Na group: | | |
| 0.2 meq/g | | |
| Cyclohexanone | 150.0 | parts |
| Methyl ethyl ketone | 150.0 | parts |
| (Abrasive Solution) | | |
| Alumina dispersion prepared in the section (1) | 6.0 | parts |
| (Silica Sol (Protrusion Forming Agent Liquid)) | | |
| Colloidal silica (average particle size: 120 nm) | 2.0 | parts |
| Methyl ethyl ketone | 1.4 | parts |
| (Other Components) | | |
| Stearic acid | 2.0 | parts |
| Stearic acid amide | 0.2 | parts |
| Butyl stearate | 2.0 | parts |
| Polyisocyanate (CORONATE (registered trademark) L | 2.5 | parts |
| manufactured by Tosoh Corporation) | | |
| (Solvent-1) | | |
| Cyclohexanone | 200.0 | parts |
| Methyl ethyl ketone | 200.0 | parts |
| (Solvent-2) | | |
| Cyclohexanone | 350.0 | parts |
| Methyl ethyl ketone | 350.0 | parts |

(3) Formulation of Non-Magnetic Layer Forming Composition

| | | |
|---|---|---|
| Non-magnetic inorganic powder: α-iron oxide | 100.0 | parts |
| Average particle size (average long axis length): 0.15 μm | | |
| Average acicular ratio: 7 | | |
| BET specific surface area: 52 m²/g | | |
| Carbon black | 20.0 | parts |
| Average particle size: 20 nm | | |
| SO₃Na group-containing polyurethane resin | 18.0 | parts |
| Weight-average molecular weight: 70,000, SO₃Na group: | | |
| 0.2 meq/g | | |
| Stearic acid | 2.0 | parts |
| Stearic acid amide | 0.2 | parts |
| Butyl stearate | 2.0 | parts |
| Cyclohexanone | 300.0 | parts |
| Methyl ethyl ketone | 300.0 | parts |

(4) Preparation of Each Layer Forming Composition

The magnetic layer forming composition was prepared by the following method. The magnetic liquid was prepared by dispersing the above components for 24 hours (beads-dispersion) using a batch type vertical sand mill. As dispersion beads, zirconia beads having a bead diameter of 0.5 mm were used. Using the sand mill, the prepared magnetic liquid was mixed with the abrasive liquid, the silica sol, other components, and the solvent-1 and the mixture was beads-dispersed for 5 minutes, and then the treatment (ultrasonic dispersion) was performed on the mixture for 0.5 minutes by a batch type ultrasonic device (20 kHz, 300 W). Thereafter, filtration was performed using a filter having a pore diameter of 0.5 μm, and then the solvent-2 was added to prepare a magnetic layer forming composition.

A non-magnetic layer forming composition was prepared by the following method. The components described above excluding the lubricant (stearic acid, stearic acid amide, and butyl stearate) were kneaded and diluted by an open kneader, and subjected to a dispersion treatment by a horizontal beads mill disperser. After that, the lubricant (stearic acid, stearic acid amide, and butyl stearate) was added into the obtained dispersion liquid and stirred and mixed by a dissolver stirrer to prepare a non-magnetic layer forming composition.

The composition prepared in the same manner as the non-magnetic layer forming composition was diluted by adding the following solvent thereto, thereby preparing a back coating layer forming composition.

| | |
|---|---|
| Cyclohexanone | 300.0 parts |
| Methyl ethyl ketone | 300.0 parts |

(5) Manufacturing Method of Magnetic Tape

The non-magnetic layer forming composition was applied onto a surface of the support shown in Table 1 and was dried so that the thickness after drying was 1.0 μm, and thus a non-magnetic layer was formed.

Next, the magnetic layer forming composition was applied onto a surface of the non-magnetic layer and was dried so that the thickness after drying was 0.1 μm, and thus a magnetic layer was formed.

After that, the back coating layer forming composition was applied onto a surface of the support opposite to the surface on which the non-magnetic layer and the magnetic layer are formed and was dried so that the thickness after drying was 0.5 μm, and thus, a back coating layer was formed.

Thereafter, a surface smoothing treatment (calendering treatment) was performed twice using a calendar roll formed of two metal rolls at a speed of 20 m/min, a linear pressure of 320 kN/m (327 kg/cm), and a calendar temperature of 95° C. (surface temperature of calendar roll), and after that, a heat treatment was performed by storing the original roll in a heat treatment furnace at the atmosphere temperature in the furnace of 70° C. for 36 hours.

From the magnetic tape original roll thus manufactured, a magnetic tape to be used for evaluation described below was obtained by cutting a portion where a support portion is a PEKK film at a bonded location with a portion where a support portion was a polyethylene terephthalate film.

### Examples 2 to 5 and Comparative Examples 1 to 7

A magnetic tape original roll was manufactured in the same manner as in Example 1, except that the support and/or ferromagnetic powder shown in Table 1 were used.

In Examples 2 to 5 and Comparative Examples 1 to 4, as in Example 1, a magnetic tape used for evaluation described below was obtained by cutting a portion where a support portion is a PEEK film or a PEKK film from the magnetic tape original roll.

In Comparative Examples 5 to 7, a magnetic tape obtained by cutting out a region of an optional length of the magnetic tape original roll was used for evaluation described below.

[Manufacturing Method of Ferromagnetic Powder]

<Manufacturing Method of Hexagonal Strontium Ferrite Powder>

“SrFe” shown in Table 1 is hexagonal strontium ferrite powder manufactured by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

The hexagonal strontium ferrite powder (“SrFe 1” in Table 1) obtained above had an average particle size of 18 nm, an activation volume of 902 nm³, an anisotropy constant Ku of 2.2×10⁵ J/m³, and a mass magnetization σs of 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.
PANalytical X'Pert Pro diffractometer, PIXcel detector
Soller slit of incident beam and diffracted beam: 0.017 radians
Fixed angle of dispersion slit: ¼ degrees
Mask: 10 mm
Anti-scattering slit: ¼ degrees
Measurement mode: continuous
Measurement time per stage: 3 seconds
Measurement speed: 0.017 degrees per second
Measurement step: 0.05 degrees

<Manufacturing Method of ε-Iron Oxide Powder>

“ε-Iron oxide” shown in Table 1 is ε-iron oxide powder manufactured by the following method.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at a furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at a furnace temperature of 80° C. for 24 hours to obtain a ferromagnetic powder precursor.

The obtained ferromagnetic powder precursor was loaded into a heating furnace at a furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis is performed under the same condition as that described above for the manufacturing method of hexagonal strontium ferrite powder, and from a peak of an X-ray diffraction pattern, it is checked that the obtained ferromagnetic powder does not include α-phase and γ-phase crystal structures, and has a single-phase and 8-phase crystal structure (ε-iron oxide type crystal structure).

The obtained ε-iron oxide powder (“ε-iron oxide” in Table 1) had an average particle size of 12 nm, an activation volume of 746 nm³, an anisotropy constant Ku of 1.2×10⁵ J/m³, and a mass magnetization σs of 16 A·m²/kg.

[Evaluation Method]

<Center-Line Average Roughness Ra of Surface of Magnetic Layer of Magnetic Tape>

A sample piece cut out from each magnetic tape of Examples and Comparative Examples was attached onto a slide glass with the magnetic layer surface facing upward such that no wrinkles were visually confirmed. This slide glass was placed on a newview 6300 type optical interference roughness meter manufactured by Zygo Corporation, and the center-line average roughness Ra of the magnetic layer surface was obtained by the method described above. For the filter processing, software metropro 8.3.5 for the optical interference roughness meter was used. The obtained value is shown in the row of “Center-line average roughness Ra” of “Magnetic tape” in Table 1.

<Creep Change Amount of Magnetic Tape Measured by Thermal Mechanical Analysis (TMA)>

In an evaluation environment of an atmosphere temperature of 35° C. and a relative humidity of 50%, a creep change amount measured by the TMA was obtained by the following method using TMA/SS6100 manufactured by Hitachi High-Tech Science Corporation as an evaluation device.

A sample having a length of 15.0 mm and a width of 5.0 mm was cut out from a longitudinal direction of each magnetic tape of Examples and Comparative Examples, and the sample was fixed to the above-described evaluation device such that a distance between chucks is 10.0 mm, and a load was applied in the longitudinal direction in two stages. The first stage was held with a load of 39.2 mN for 2 hours, and the second stage was further held with a load of 392 mN for additional 24 hours. A sample length at 10 hours after the start of the second-stage load application (hereafter, “sample length 1”) and a sample length at 24 hours after the start of the second-stage load application (hereafter, “sample length 2”) were measured, respectively. These sample lengths are lengths in the longitudinal direction, and the unit is μm. The creep change amount measured by the TMA was calculated as “creep change amount measured by TMA=sample length 2−sample length 1”. The calculated value is shown in the row of “Creep change amount measured by TMA” in Table 1.

<Thickness of Non-Magnetic Support>

From each magnetic tape of Examples and Comparative Examples, a sample for cross section observation was manufactured by a method described below. As SEM for SEM observation, FE-SEM S4800 manufactured by Hitachi, Ltd., which is a field emission (FE)-scanning electron microscope (SEM), was used.

(i) A sample having a size of 10 mm in a width direction and 10 mm in a longitudinal direction of the magnetic tape was cut out using a razor.

A protective film was formed on a magnetic layer surface of the cut sample to obtain a sample with a protective film. The formation of the protective film was performed by the following method.

A platinum (Pt) film (thickness of 30 nm) was formed on the magnetic layer surface of the sample by sputtering. The sputtering of the platinum film was performed under the following conditions.

(Sputtering Condition for Platinum Film)
Target: Pt
Degree of vacuum in chamber of sputtering device: 7 Pa or less
Current value: 15 mA

A carbon film having a thickness of 100 to 150 nm was further formed on the above-manufactured sample with a platinum film. The formation of the carbon film was performed by a chemical vapor deposition (CVD) mechanism using a gallium ion (Gat) beam provided in a focused ion beam (FIB) device used in the following (ii).

(ii) FIB processing using a gallium ion (Gat) beam was performed on the sample with a protective film manufactured in the above (i) using a FIB device to expose a cross section of the magnetic tape. An acceleration voltage in FIB processing was 30 kV, and a probe current was 1,300 pA.

The sample for cross section observation exposed in this way was observed by SEM, and an SEM image of the cross section was acquired. A total of ten SEM images were acquired at ten randomly selected locations of the manufactured sample for cross section observation. Each SEM image was acquired as a secondary electron image captured at an acceleration voltage of 5 kV, an imaging magnification of 20000×, and 960 vertical pixels×1280 horizontal pixels. An interface between the magnetic layer and the non-magnetic layer was specified by a method disclosed in a paragraph 0029 of JP2017-33617A. An interface between the non-magnetic layer and the non-magnetic support and an interface between the back coating layer and the non-magnetic support were specified by visually observing an SEM image. At any one position on each SEM image, an interval between the interface between the magnetic layer and the non-magnetic layer and the outermost surface on the magnetic layer side of the magnetic tape in a thickness direction was measured, and an arithmetic average of values obtained for 10 images was calculated as a thickness of the magnetic layer. At any one position on each SEM image, an interval between the interface of the non-magnetic layer with the magnetic layer and the interface of the non-magnetic layer with the non-magnetic support in a thickness direction was measured, and an arithmetic average of values obtained for 10 images was calculated as a thickness of the non-magnetic layer. At any one position on each SEM image, an interval between the outermost surface on the back coating layer side of the magnetic tape and the interface between the back coating layer and the non-magnetic support in a thickness direction was measured, and an arithmetic average of values obtained for 10 images was calculated as a thickness of the back coating layer. At any one position on each SEM image, an interval between the interface between the interface of the non-magnetic support with the back coating layer and the interface of the non-magnetic support with the non-magnetic layer in a thickness direction was measured, and an arithmetic average of values obtained for 10 images was calculated as a thickness of the non-magnetic layer. The thickness of the non-magnetic support thus obtained is shown in the row of “Thickness” of “Non-magnetic support” in Table 1. In all the magnetic tapes of Examples and Comparative Examples, the thicknesses of the non-magnetic layer, the magnetic layer, and the back coating layer were such that the non-magnetic layer: 1.0 μm, the magnetic layer: 0.1 μm, and the back coating layer: 0.5 μm.

The evaluation described below was executed on the support taken out by removing the non-magnetic layer, the magnetic layer, and the back coating layer of each magnetic tape of Examples and Comparative Examples, with a solvent. The support was taken out such that an unnecessarily large amount of external energy (stress, heat, or the like) was not applied to the support by the take-out treatment.

<Scattering Intensity Ratio of Non-Magnetic Support Iₘₐₓ/Iₘᵢₙ>

For the support taken out from each magnetic tape of Examples and Comparative Examples, small-angle X-ray scattering measurement was performed as described above using NANOSTAR manufactured by BRUKER as a measuring device. From the measurement results, the scattering intensity ratio Iₘₐₓ/Iₘᵢₙ was obtained by the method described above. A rotating anticathode X-ray generation apparatus was used as an X-ray source, and the energy (wavelength λ) of the X-ray was set to 8.04 keV (Cu Kα-ray of 1.5418 Å). In addition, the transmittance T was measured using glassy carbon as a standard sample. The obtained value is shown in the row of “Scattering intensity ratio Iₘₐₓ/Iₘᵢₙ” of “Non-magnetic support” in Table 1.

<Glass Transition Temperature Tg of Non-Magnetic Support>

A sample piece having a mass of 10 mg was cut out from the support taken out from each magnetic tape of Examples and Comparative Examples, and this sample piece was used to obtain the glass transition temperature Tg by the method described above using a Q100 type manufactured by TA instruments as the DSC. The obtained value is shown in the row of “Glass transition temperature Tg” of “Non-magnetic support” in Table 1. In Comparative Example 7, since the glass transition temperature Tg was not confirmed at 140° C. or lower, “Exceeding 140° C.” is described in Table 1.

<Center-Line Average Roughness Ra of Surface of Non-Magnetic Support on Side Having Magnetic Layer>

A sample piece cut out from the support taken out from each magnetic tape of Examples and Comparative Examples was attached onto a slide glass with the surface on a side having the magnetic layer facing upward such that no wrinkles were visually confirmed. This slide glass was placed on a newview 6300 type optical interference roughness meter manufactured by Zygo Corporation, and the center-line average roughness Ra of the surface of the non-magnetic support on the side having the magnetic layer was obtained by the method described above. For the filter processing, software metropro 8.3.5 for the optical interference roughness meter was used. The obtained value is shown in the row of “Center-line average roughness Ra” of “Non-magnetic support” in Table 1.

The above results are shown in Table 1.

TABLE 1

| | | | | | | | Comparative |
|---|---|---|---|---|---|---|---|
| | | Example 1 | Example 2 | Example 3 | Example 4 | Example 5 | Example 1 |
| Ferromagnetic powder | | BaFe | BaFe | BaFe | SrFe | ε-Iron | BaFe |
| | | | | | | oxide | |
| Non- | Resin | PEEK | PEEK | PEKK | PEEK | PEEK | PEEK |
| Magnetic | Stretching | 3.0/3.0 | 3.1/3.1 | 3.3/3.3 | 3.0/3.0 | 3.0/3.0 | 2.5/2.5 |
| support | ratio | | | | | | |
| | (longitudinal | | | | | | |
| | direction/ | | | | | | |
| | width | | | | | | |
| | direction) | | | | | | |
| | Stretching | 160 | 160 | 158 | 160 | 160 | 160 |
| | temperature | | | | | | |
| | (° C.) | | | | | | |
| | Stretching rate | 300 | 300 | 300 | 300 | 300 | 300 |
| | (%/min) | | | | | | |
| | Thickness | 5.0 | 5.0 | 5.0 | 5.0 | 5.0 | 5.0 |
| | (nm) | | | | | | |
| | Scattering | 3.0 | 3.1 | 2.9 | 3.0 | 3.0 | 2.5 |
| | intensity ratio | | | | | | |
| | Iₘₐₓ/Iₘᵢₙ | | | | | | |
| | Glass transition | 143 | 143 | 162 | 143 | 143 | 143 |
| | temperatureTg | | | | | | |
| | (° C.) | | | | | | |
| | Center-line | 10.0 | 10.0 | 2.5 | 10.0 | 10.0 | 10.0 |
| | average | | | | | | |
| | roughness Ra | | | | | | |
| | (nm) | | | | | | |
| Magnetic | Center-line | 3.5 | 3.5 | 1.6 | 3.6 | 3.7 | 3.5 |
| tape | average | | | | | | |
| | roughness Ra | | | | | | |
| | (nm) | | | | | | |
| | Creep change | 0.25 | 0.25 | 0.24 | 0.25 | 0.25 | 0.31 |
| | amount | | | | | | |
| | measured by | | | | | | |
| | TMA (μm) | | | | | | |

| | | Comparative | Comparative | Comparative | Comparative | Comparative | Comparative |
|---|---|---|---|---|---|---|---|
| | | Example 2 | Example 3 | Example 4 | Example 5 | Example 6 | Example 7 |
| Ferromagnetic powder | | BaFe | BaFe | BaFe | BaFe | BaFe | BaFe |
| Non- | Resin | PEEK | PEEK | PEKK | PET | PEN | Aromatic |
| Magnetic | | | | | | | polyamide |
| support | Stretching | 2.0/2.0 | None | 3.3/3.3 | — | — | — |
| | ratio | | | | | | |
| | (longitudinal | | | | | | |
| | direction/ | | | | | | |
| | width | | | | | | |
| | direction) | | | | | | |
| | Stretching | 160 | — | 180 | — | — | — |
| | temperature | | | | | | |
| | (° C.) | | | | | | |
| | Stretching rate | 300 | — | 300 | — | — | — |
| | (%/min) | | | | | | |
| | Thickness (nm) | 5.0 | 5.0 | 5.0 | 4.6 | 4.6 | 3.6 |
| | Scattering | 2.3 | 1.4 | 2.0 | 1.3 | less than 1.0 | less than 1.0 |
| | intensity ratio | | | | | | |
| | Iₘₐₓ/Iₘᵢₙ | | | | | | |
| | Glass transition | 143 | 143 | 162 | 81 | 120 | more than |
| | temperatureTg | | | | | | 140° C. |
| | (° C.) | | | | | | |
| | Center-line | 10.0 | 10.0 | 18.0 | 1.9 | 3.4 | 0.5 |
| | average | | | | | | |
| | roughness Ra | | | | | | |
| | (nm) | | | | | | |
| Magnetic | Center-line | 3.5 | 3.5 | 5.5 | 1.5 | 1.7 | 1.0 |
| tape | average | | | | | | |
| | roughness Ra | | | | | | |
| | (nm) | | | | | | |
| | Creep change | 0.32 | 0.33 | 0.32 | 0.80 | 0.52 | 0.54 |
| | amount | | | | | | |
| | measured by | | | | | | |
| | TMA (μm) | | | | | | |

From the values of the creep change amount measured by the TMA shown in Table 1, it can be evaluated that the magnetic tapes of Examples 1 to 3 are magnetic tapes that can meet needs for suppressing tape deformation in long-term storage, which are required for future magnetic tapes.

In the “2019 INSIC Technology Roadmap” published by the information storage industry consortium (INSIC), the tape technology roadmap states that the tape dimensional stability (hereinafter, referred to as “TDS”) targeted for 2029 in terms of the deformation in the width direction of the magnetic tape in a state of being wound around a reel is 32 parts per million (ppm) or less in storage for 10 years. As the recording density increases, a value of the TDS allowed for the product magnetic tape tends to decrease from the viewpoint of suppressing the occurrence of an error during recording and/or reproduction. In this regard, a magnetic tape capable of achieving the TDS of 32 ppm or less in storage for 10 years is suitable, for example, in a magnetic recording and reproducing system with a track density of 50000 track per inch (TPI) (about 500 nm/track) or more, and further in a magnetic recording and reproducing system with a track density of 75000 TPI or more, 100000 TPI or more, and even 200000 TPI or more.

On the other hand, regarding the deformation of the magnetic tape, in FIG. 9 of “Journal of Applied Polymer Science, Vol. 102, 1106 to 1128 (2006) “Viscoelastic analysis applied to the determination of long-term creep behavior for magnetic tape materials”” (written by Brian L. Weick, published online at Wiley InterScience), it has been proposed to predict a creep change amount of the magnetic tape after long-term storage from the creep change amount obtained by the creep test. Specifically, in FIG. 9, a graph having a substantially straight line is obtained by plotting the logarithm of time log on a horizontal axis and the logarithm of creep change amount log on a vertical axis. Therefore, assuming that a proportional relationship is established between the logarithm of time log and the creep change amount, the following calculation was performed.

Since the creep change amount measured by TMA shown in Table 1 is a difference between the sample length at 10 hours and the sample length at 24 hours after the end of the two-stage load application, the creep change amount measured by TMA is a creep change amount occurring during 14 hours. In a case where 14 hours are represented as a logarithm log, it is about 1.15. On the other hand, 10 years=87600 hours, and, in a case where this is represented as a logarithm log, it is about 4.94. As a coefficient for proportional calculation with time (logarithm), “logarithmic representation of 87600 hours/logarithmic representation of 10 hours=4.31” is adopted. In addition, in the same document, Poisson's ratio=0.3 is adopted in order to convert the deformation in the longitudinal direction into the deformation in the width direction. In a case where the creep change amount measured by TMA, which was obtained by the method described above, is denoted by “A”, and standardized with a distance between chucks of 10.0 mm as a reference length, “standardized A=(A/10000)×10⁶” (unit: ppm) can be calculated. This standardized A is the amount of deformation in the longitudinal direction, and, using Poisson's ratio=0.3, a value B converted into the amount of deformation in the width direction can be obtained as “B=standardized A×0.3”. The predicted value of the TDS expected to occur in storage for 10 years was calculated as “B×4.31” obtained by multiplying the B obtained here by the coefficient 4.31. The value thus calculated is shown in Table 2. As shown in Table 2, in Examples 1 to 5, the predicted 10-years storage TDS value was 32 ppm or less. From the result, it can be evaluated that the magnetic tapes of Examples 1 to 5 are magnetic tapes that can meet needs for suppressing tape deformation in long-term storage, which are required for future magnetic tapes.

TABLE 2

| | Example 1 | Example 2 | Example 3 | Example 4 | Example 5 |
|---|---|---|---|---|---|
| Predicted 10- | 32 | 32 | 31 | 32 | 32 |
| years storage | | | | | |
| TDS value | | | | | |
| (ppm) | | | | | |

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Predicted 10- | 40 | 41 | 43 | 41 | 103 | 67 | 70 |
| years storage | | | | | | | |
| TDS value | | | | | | | |
| (ppm) | | | | | | | |

One aspect of the present invention is effective in data storage applications.

What is claimed is:

1. A magnetic tape comprising:
a non-magnetic support; and
a magnetic layer containing a ferromagnetic powder,
wherein, in a small-angle X-ray scattering spectrum obtained by small-angle X-ray scattering measurement of the non-magnetic support, in a region where a q-value is 0.01 to 0.10 Å⁻¹, a ratio Iₘₐₓ/Iₘᵢₙ of a scattering intensity Iₘₐₓ at a q-value qₘₐₓ of a maximal value of a scattering intensity change rate to a scattering intensity Iₘᵢₙ at a q-value qₘᵢₙ of a minimal value of the scattering intensity change rate is 2.7 or more, and qₘᵢₙ<qₘₐₓ is satisfied, and
a glass transition temperature Tg of the non-magnetic support is 140° C. or higher.

2. The magnetic tape according to claim 1,
wherein the non-magnetic support is a support including an aromatic polyether ketone.

3. The magnetic tape according to claim 2,
wherein the aromatic polyether ketone is a polyether ether ketone.

4. The magnetic tape according to claim 2,
wherein the aromatic polyether ketone is a polyether ketone ketone.

5. The magnetic tape according to claim 1,
wherein the ferromagnetic powder is a hexagonal barium ferrite powder.

6. The magnetic tape according to claim 1,
wherein the ferromagnetic powder is a hexagonal strontium ferrite powder.

7. The magnetic tape according to claim 1,
wherein the ferromagnetic powder is an ε-iron oxide powder.

8. The magnetic tape according to claim 1, further comprising:
a non-magnetic layer containing a non-magnetic powder between the non-magnetic support and the magnetic layer.

9. The magnetic tape according to claim 1, further comprising:
a back coating layer containing a non-magnetic powder on a surface side of the non-magnetic support opposite to a surface side having the magnetic layer.

10. The magnetic tape according to claim 1,
wherein a center-line average roughness Ra of a surface of the non-magnetic support on a side having the magnetic layer, which is measured by an optical interference roughness meter, is 15.0 nm or less.

11. The magnetic tape according to claim 2,
wherein a center-line average roughness Ra of a surface of the non-magnetic support on a side having the magnetic layer, which is measured by an optical interference roughness meter, is 15.0 nm or less.

12. The magnetic tape according to claim 3,
wherein a center-line average roughness Ra of a surface of the non-magnetic support on a side having the magnetic layer, which is measured by an optical interference roughness meter, is 15.0 nm or less.

13. The magnetic tape according to claim 4,
wherein a center-line average roughness Ra of a surface of the non-magnetic support on a side having the magnetic layer, which is measured by an optical interference roughness meter, is 15.0 nm or less.

14. A magnetic tape cartridge comprising:
the magnetic tape according to claim 1.

15. A magnetic recording and reproducing apparatus comprising:
the magnetic tape according to claim 1.
